(19) United States
(12) Patent Application Publication
(10) Pub. No.: US 2014/0115246 A1
(43) Pub. Date: Apr. 24, 2014

(54) APPARATUS, SYSTEM AND METHOD FOR MANAGING EMPTY BLOCKS IN A CACHE

(71) Applicant: ORACLE INTERNATIONAL CORPORATION, Redwood City, CA (US)

(72) Inventor: Mark Maybee, Boulder, CO (US)

(73) Assignee: ORACLE INTERNATIONAL CORPORATION, Redwood CIty, CA (US)

(21) Appl. No.: 13/656,421

(22) Filed: Oct. 19, 2012

(51) Int. Cl. G06F 12/08

(52) U.S. Cl. 711/105; 711/133; 711/E12.022

(57) ABSTRACT

Aspects of the present disclosure disclose systems and methods for recognizing multiple and distinct references within a cache that identify or otherwise provide access to empty blocks of data. Multiple references identifying empty blocks of data are associated with a single block of empty data permanently stored in the cache. Subsequently, each time an empty block of data is added to the cache, a reference corresponding to the empty block is mapped to a generic empty block of data stored in the cache. When a reference is removed or deleted from the cache, only the reference is deleted; the single generic block of empty data continues to reside in the cache.

### TECHNICAL FIELD

Aspects of the present disclosure relate to computing systems, and in particular, systems and methods for managing memory by reducing or eliminating empty blocks of data within a cache.

### BACKGROUND

In an attempt to mitigate the impact of the growing gap between CPU speeds and memory performance, many computer architectures implement hierarchical memory structures. For example, in many computer architectures, one or more memory caches may be implemented between the CPU and the main memory. Memory caches, which are faster than main memory, are designed to contain copies of main memory blocks of data in an attempt to speed up accesses to frequently needed data.

However, due to cost and other limitations, conventional caches are typically small compared to main memory and only hold a limited amount of data. Thus, once a cache has become full data must be removed and/or replaced when new data arrives. Caches can only improve performance if data blocks which have already been loaded in the cache are reused before being replaced. Thus, the management of cache capacity and data use is critical.

It is with these concepts in mind, among others, that aspects of the present disclosure were conceived.

### SUMMARY

One aspect of the present disclosure involves a system for managing empty data blocks in a cache. The system includes a memory. The system further includes at least one processor in operable communication with the memory. The processor is configured to identify a reference to a first empty block of data to be stored in a cache of a file system and map the reference to an existing second empty block of data stored in the cache. The processor is configured to add the reference to a cache list maintaining the cache.

Aspects of the present disclosure include methods for managing empty data blocks in a cache. The method may be performed or otherwise executed by a processor. The method includes identifying a reference to a first empty block of data to be stored in a cache of a file system. The method also includes mapping the reference to an existing second empty block of data stored in the cache. The method further includes adding the reference to a cache list maintaining the cache.

Aspects of the present disclosure include non-transitory computer readable mediums encoded with instructions for managing cache executable by a processor. The instructions include identifying a reference to a first empty block of data to be stored in a cache of a file system. The instructions further include map the reference to an existing second empty block of data stored in the cache. The instructions include adding the reference to a cache list maintaining the cache.

### BRIEF DESCRIPTION OF THE FIGURES

Aspects of the present disclosure may be better understood and its numerous objects, features, and advantages made apparent to those skilled in the art by referencing the accompanying drawings. It should be understood that these drawings depict only typical embodiments of the present disclosure and, therefore, are not to be considered limiting in scope.

FIG. 1 is an example computing environment for managing a cache in accordance with one aspect of the present disclosure.

FIG. 2 is a block diagram of a file system data blocks in accordance with one aspect of the present disclosure.

FIG. 3 is an example process for managing a cache in accordance with one aspect of the present disclosure.

FIG. 4 is an example computing system n accordance with one aspect of the present disclosure.

### DETAILED DESCRIPTION

Aspects of the present disclosure describe systems and methods for recognizing multiple and distinct references within a cache that identify or otherwise provide access to empty blocks of data. In various aspects, the references identifying the empty blocks of data are associated with a single block of empty data permanently stored in the cache, resulting in the de-duplication of the empty blocks within the cache. In particular, each time a reference to an empty block of data is added to the cache, the reference corresponding to the empty block may be mapped to the single empty block of data stored in the cache, resulting in the reduction or elimination of duplicate empty blocks of data being stored. When a empty block is removed or evicted from the cache, only the reference is removed; the single block of empty data continues to reside in the cache. Therefore, the cache memory is optimized for storage of non-empty blocks of data thereby increasing the available cache capacity without adding additional cache memory, among other advantages.

A cache represents a mechanism used within various computing devices and/or resources to reduce the average wait time to access memory, disk storage, etc. In particular, the cache represents a smaller, faster memory capable of storing copies of data from frequently used or otherwise important main memory locations so that future requests for the data stored in the cache can be accessed faster. There are various schemes for managing the cache, including most recently used (MRU), least recently used (LRU), and numerous others. Regardless, a cache may be used to increase the speed at which data may be accessed by reducing the number of instances in which a main disk storage or main memory is accessed.

Generally, a cache has a pool of entries. An “entry” includes a specific piece of data and a reference or tag that identifies the data. The data is stored in the cache memory and a reference identifying the data is maintained in an ordered list. Conventional caches store a copy of a data block for each distinct reference added to the cache. For example, if a data block “B” is referenced from multiple applications, each of the references will generate a new cached copy of data block “B” within the cache memory upon activation of the reference, resulting in duplicate copies of data being stored. Such a phenomenon is particularly relevant for references to empty data blocks—every reference that points to an empty data block stores a copy of an empty data block into the cache, resulting in large numbers of duplicate empty blocks being stored in the cache. An empty data block is easily identifiable as it typically involves a discrete chunk, such as 128K or 256K of zero values. The management of empty data blocks within a cache may significantly improve cache capacity and effectiveness. In particular, instead of storing large numbers of empty data blocks in a cache, only a single empty data block may be stored. Subsequently, any time the system attempts to add a new empty data block to the cache, the reference pointing to the new empty data block may be mapped and/or associated with the existing empty data block stored in the cache. Stated differently, aspects of the present disclosure automatically reserve an empty block of data in a cache and manage the references attempting to access empty data by mapping the empty block to all of the other locations where an empty block of data would normally be stored. Such a methodology limits the amount of duplicate empty data blocks stored in the cache, providing significant gains in cache capacity and performance.

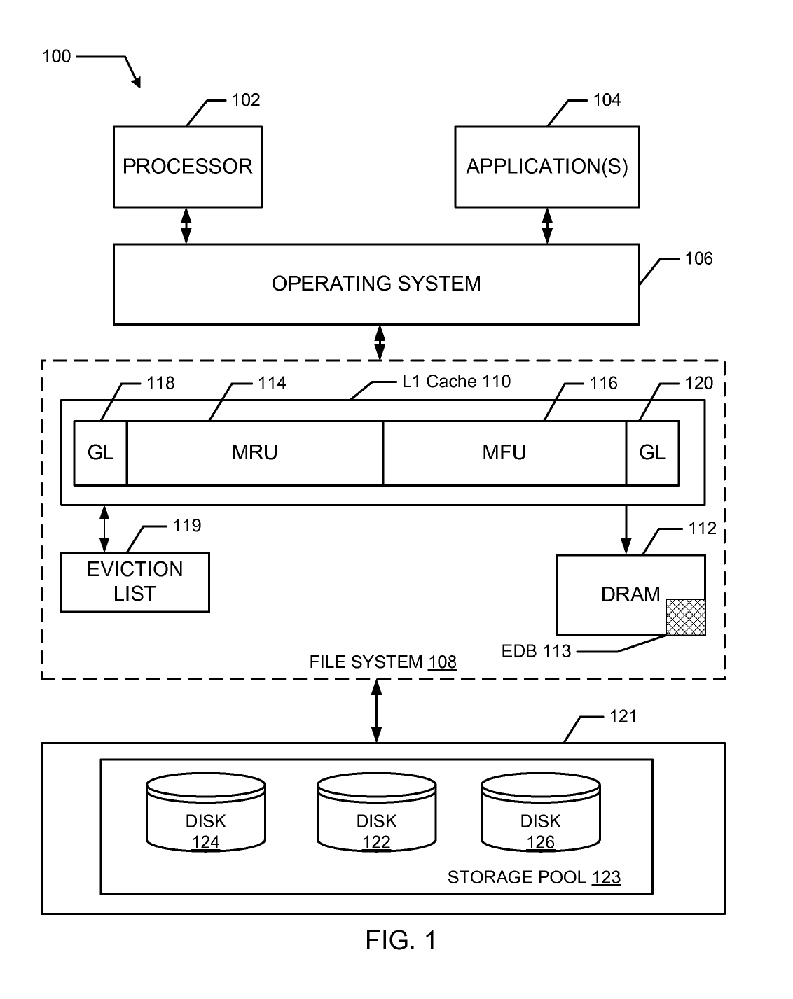

FIG. 1 illustrates an example computing architecture 100 for managing empty blocks of data in a cache. The computing environment 100 may include at least one processor 102, which may be capable of processing various instructions of a computer program, such as application(s) 104, by performing basic arithmetical, logical, and/or input/output operations, etc. The processor 102 may be included in various devices such as a personal computer, work station, server, mobile device, mobile phone, tablet device, processor, and/or other processing device capable of implementing and/or executing instructions, processes, software, applications, etc.

The application 102 may interface with an operating system 106, which may include functionality to interact with a file system 108. For example, the operating system 106 interfaces with the file system 108 via a system call interface (not shown). The operating system 106 provides operations for users to access files within the file system 108, such as read, write, open, close, etc. The file system 108 may be an object-based file system in which both data and metadata are stored as objects within the file system. In particular, the file system 108 may include functionality to store both data and corresponding metadata in a storage device, such as disk 122. Accordingly, the various operations provided by the operating system 106 correspond to operations on objects. For example, a request to perform a particular operation (i.e., a transaction) is forwarded from the operating system 106, using the system call interface, to the file system 108. In response, the file system 108 may translate the request to perform an operation on an object directly into a request to perform a read or write operation (i.e., an I/O request) at a physical location within the disk 122.

In one particular embodiment, the file system 108 may be a ZFS file system. ZFS represents a combined file system and logical volume manager designed by Oracle®. The features of ZFS include data integrity verification against data corruption modes, support for high storage capacities, integration of the concepts of file system and volume management, snapshots and copy-on-write clones, continuous integrity checking and automatic repair, RAID-Z and native NFSv4 ACLs, and the like. ZFS stores and/or otherwise organizes data into objects known as data “blocks.”

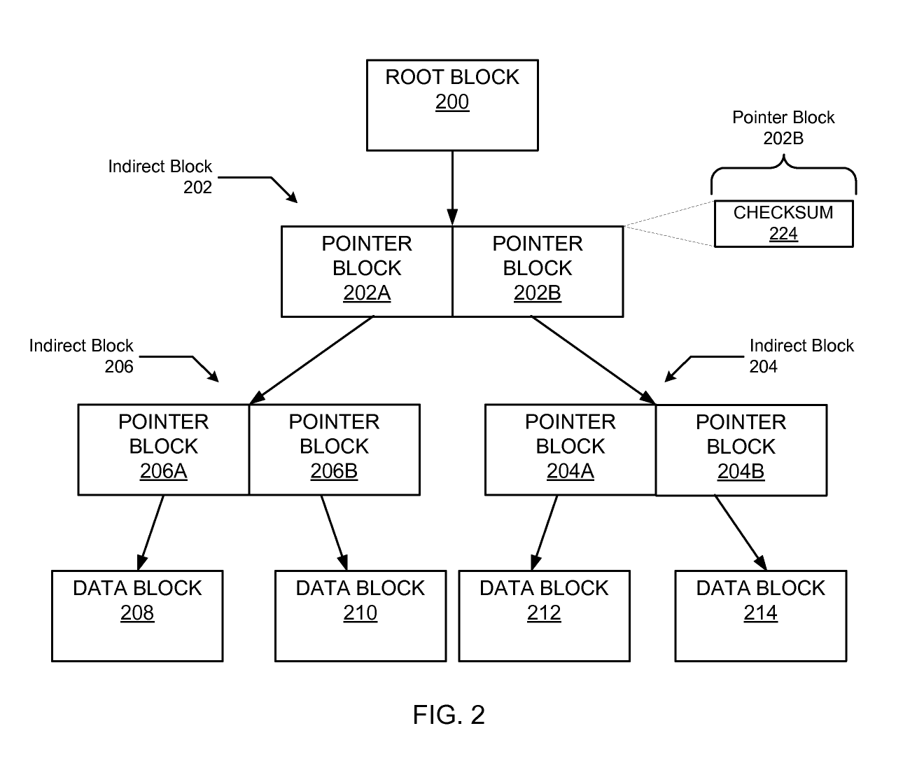

FIG. 2 is a diagram illustrating a hierarchical data configuration (hereinafter referred to as a “tree”) for storing data blocks within a ZFS file system. The tree includes a root or uber block 200, one or more levels of indirect blocks (202, 204, 206), and one or more data blocks (208, 210, 212, 214). The location of the root block 200 is in a particular location within the disk 122. Additionally, the root block 200 may point to subsequent indirect blocks (202, 204, and 206), which may be arrays of block pointers (202A, 202B, 204A, 204B, 206A, 206B) that, directly or indirectly, reference data blocks (208, 210, 212, 214). The data blocks (208, 210, 212, 214) contain actual data of files. Several layers of indirect blocks may exist between the root block 200 and the data blocks (208, 210, 212, 214).

The root block 200 and each block pointer (202A, 202B, etc.) may include a checksum 224, as illustrated in the expanded diagram of block pointer 202B, which may be for example, a 256-bit checksum. A checksum represents a datum or value computed for an arbitrary block of data for the purpose of detecting accidental errors that may have been introduced during transmission or storage of the data. The integrity of the data can be checked at any time by re-calculating the checksum and comparing it with the stored value. If the checksums match, the data was almost certainly not altered or corrupted. The checksum, as will be further described below, may be used to determine whether a request for data corresponds to a request for an empty block of data. The data blocks (208, 210, 212, and 214) do not include such information; rather, data blocks (208, 210, 212, and 214) contain the actual data of files within the ZFS file system.

Referring again to FIG. 1, the file system 108 may interface or otherwise include an L1 cache 110 capable of storing one or more data objects (e.g. blocks) for frequent and fast data access. The L1 cache 110 may be any type of cache and may use various forms of relatively fast memory. In one particular embodiment, the cache may be an Adaptive Replacement Cache (“ARC”) implemented in and/or in conjunction with dynamic random access memory (“DRAM”) 112.

In an ARC implementation, the entries entered into the L1 cache 110 may be maintained or managed in an ordered cache list (not shown) and sorted based on the time of most recent access. Accordingly, new entries into the L1 cache 110 are added at the top of the cache list, after the last entry on the list has been evicted. The new entry added at the top of the list pushes all of the other entries down. Each slot in the ordered cache list identifies specific physical data stored in DRAM 112. For example, each slot in the ordered cache list may be a reference pointing to a specific address and/or location in the DRAM 112. DRAM 112 may be any type or format and size of dynamic random access memory and may store an empty block of data (“EDB”) 113, which may be any size; however, the EDB 113 will not exceed the largest block size supported by the file system 108. Stated differently, the file system 108 only supports a range of block sizes from a minimum to a maximum, such as for example a 1 megabyte maximum. The EDB 113 may be allocated to be the maximum size supported by the file system 108, or 1 megabyte. Thus, any block size of the file system 108 will be able to be mapped to the EDB 113.

The ordered cache list of the L1 cache 110 may be a limited size and may be divided into two variable lists, such as a “Most Recently Used” (“MRU”) list 114 and a “Most Frequently Used” (“MFU”) list 116, in one example. Thus, the combined MRU 114 and MFU 116 constitute a listing of all the data stored in the L1 cache, and each list (MRU and MFU) may be dynamically adjustable in size such that each list may increase or decrease in relation to the size of the other list. For example, assume the size of the L1 cache 110 was fixed at 64 MB, the MFU being 32 MB and the MRU being 32 MB. If the size of the MRU increased 12 MB to 44 MB, the MFU would be decreased proportionally in relation to the MRU or by 12 MB to 20 MB—the fixed size of the overall L1 cache 110 would not change.

The MRU 114 contains the new entries added into the cache and behaves like the ordered list described above. Accordingly, any entry added to the MRU 114 is added at the top of the list, after the last entry of the MRU 114 has been evicted, if the MRU is full. The MFU 116 contains resource entries added to the cache that have already been requested and/or accessed at least one time before the current entry, or entries that are requested/accessed frequently. For example, assume the MFU 116 contained a reference “36” pointing to data block “A”. If another request for data block “A” was transmitted from the operating system 106 to the L1 cache 110 of the file system 108, the L1 cache 110 would remove reference ‘36” from the MRU 114 and add it to the MFU 116. The MFU 116, like the MRU 114, behaves like an ordered cache list described above. Thus, referring to the example above, when reference “36’ is added to the MFU 116, the last entry of the MFU 116 is evicted if the MFU is full. Entries entered into the MFU 116 may stay there continuously as long they are referenced again before being evicted. Thus, in the example above, reference “36” would stay in the MFU as long as reference “36” was referenced again before being evicted. If reference “36” were referenced again, it would be added to the top or beginning of the MFU list.

Both the MRU 114 and the MFU 116 may be extended with ghost lists, (“GL”) (118 and 120), which are attached to the logical end of the MRU 114 and the MFU 116 respectively. The GLs are used to keep track of recently evicted cache entries from the MRU 114 and the MFU 116 lists. Thus, the MRU GL 118 tracks or records the evicted entries from the MRU 114 and MFU GL 120 tracks or records the cache entries evicted from the MFU 116. The GLs only include metadata corresponding to entries in the MRU and/or MFU and not the data itself. Rather, cache hits in the GLs 118 and 120 may be used to adapt to recent changes in the MRU 114 and/or MFU 116 usage loads. In particular, if entries are continuously being added to the MRU GL 118, it may be an indication that the size of the MRU 114 is too small and should be increased, effectively decreasing the size of the MFU 116. Alternatively, if the MFU GL 120 is continuously receiving additional entries, it may be an indication that the size of the MFU 116 is too small and should be increased, effectively decreasing the size of the MRU 114. In the way described, hits in the ghost lists may be used to dynamically adjust the size of the MRU or the MFU up to some maximum size that is constrained by the overall size of the L1 cache.

The evicted entries from the L1 cache 110 may also be tracked in an eviction list 119 that may behave like an ordered list. Specifically, when it is determined that a data block is no longer required in the L1 cache 110, the data block is referenced in the eviction list 119 for eviction. For example, the file system 108 may execute a thread or process that determines whether a particular block of data stored in L1 cache 110 should be evicted, and if so, includes a reference to the block of data in the eviction list 119. Thus, the eviction list contains data currently stored in the L1 cache 110 that may be a candidate for eviction.

The file system 108 may implement a hash table (not shown) to manage the various entries added to the MRU 114 and/or the MFU 114. A hash table is a type of data structure that uses a hash function to map identifying values, known as keys, to their associated values. Typically, a hash table is implemented as an array. Thus, the hash function is used to transform the key into the index (the hash) of an array element (the slot or bucket) where the corresponding value is to be sought. In the context of the computing architecture 100, the hash table includes values which identify or point to a particular location within the MRU 114 and/or MFU 116. At that particular location within the hash, a reference that identifies actual physical data stored in DRAM 112 is stored.

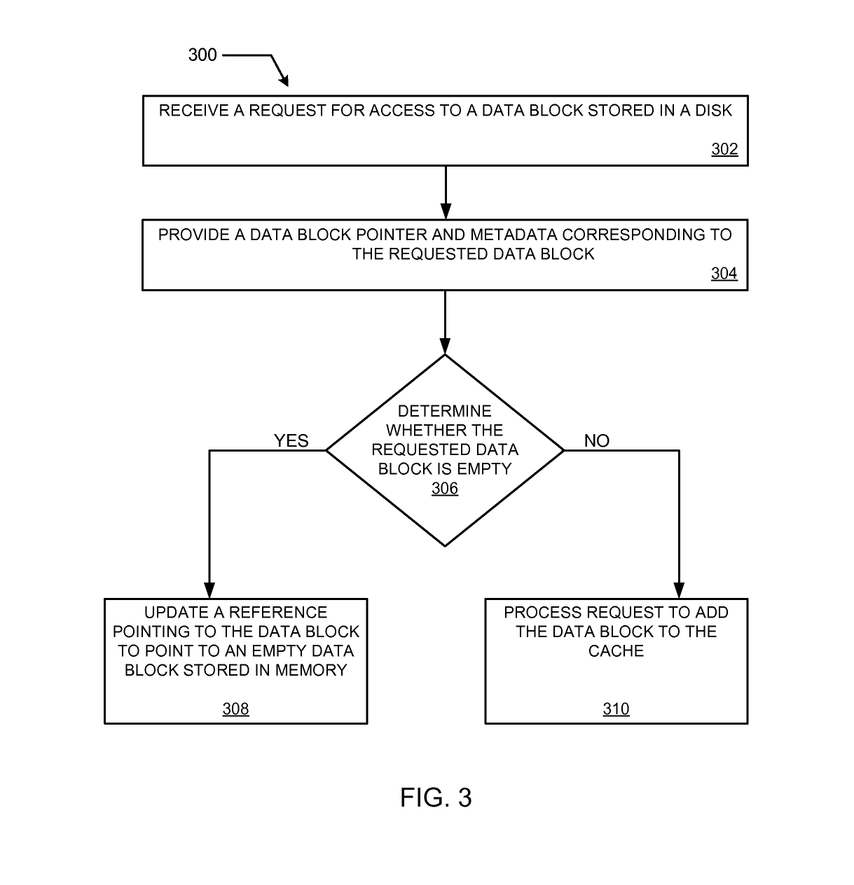

Referring now to FIGS. 1-3, in one particular embodiment, the processing device 102 may launch, run, execute, interpret, or otherwise perform various logical instructions, such as process 300, which depicts an example method for identifying and managing empty blocks of data within a cache. Process 300 begins with receiving a request for access to a block of data (operation 302). In particular, the file system 108 may receive a request (e.g. read or write) from the processor 102 to the cache 110. For example, the file system 108 may receive a write request from operating system 106 to write data at a physical location within the disk storage 122. Alternatively, the file system 108 may receive a read request from the operating system 106. In response to either the read or write request, the file system 108 may obtain a block pointer, reference, unique identify metadata, etc., corresponding to the desired block of data (operation 404).

Once a particular block of data has been identified, a type of data within the block may be identified (operation 306). In particular, the block of data and/or various characteristics of the block of data, metadata corresponding to the block of data, etc., may be analyzed to determine whether the block of data represents an empty block of data. In one embodiment, a block pointer corresponding to the requested data block may be analyzed to determine whether the block pointer is indicating that the requested data block is empty data. For example, in a ZFS file system or otherwise, the block pointer may have been tagged in a unique way, such as by including a specific flag bit within the block pointer that indicates that the data to which the block pointer is referencing is empty data stored in the disk 122. Alternatively, the block pointer may be analyzed to determine whether the pointer is referring to all zeros, or a sequence of length zero, which indicates that the block pointer is referencing empty data.

Alternatively, in another embodiment, a checksum corresponding to the requested data block may be performed or analyzed to determine whether the requested data block is an empty data block. In particular, the checksum value for the requested data block may be analyzed and compared to a checksum that is indicative of an empty block of data. Further, depending on the sizes of the empty blocks as well as other factors, a plurality of checksums may be used to compare to various possible actual empty data blocks. In particular, a repeatable and consistent checksum may be generated that can be used to determine whether a block of data is empty. Stated differently, a checksum value may be generated that corresponds to a known empty data block. Subsequently, and checksum performed against a data block that is equivalent or identical to the empty data block checksum value will also be considered an empty data block.

Finally, in yet another embodiment, the actual data within the requested block may be accessed, processed, viewed, etc., to determine whether the data block represents an empty data block. In particular, the various bits within the data block may be analyzed or processed to determine the type of data. For example, a series of bits within a given data block may be analyzed to determine whether the bits are zeros. If the bits are all zeros, it indicates that the data block is an empty data block.

When the data block is empty, a reference corresponding to the data block may be mapped to an empty data block (EDB already present) in cache (operation 308). In particular, a hash entry in the hash table of the cache 110 identifying the empty block may be updated to include a reference providing access to or otherwise referencing the EDB 113 permanently stored in the DRAM 112. For example, if entry “36” in the hash table was identified as pointing to an empty data block, the entry “36” would be updated to identify a reference within the MRU 114 or the MFU 116 pointing to or otherwise referencing the EDB 113 permanently stored in DRAM 112. The EDB may be permanently stored such that it cannot be evicted under normal LRU, MRU, or other cache management schemes. If the data block to reference “36” were not empty, the file system 108 may process the request for data in the conventional manner required to execute the specific operation articulated in the request (operation 310).

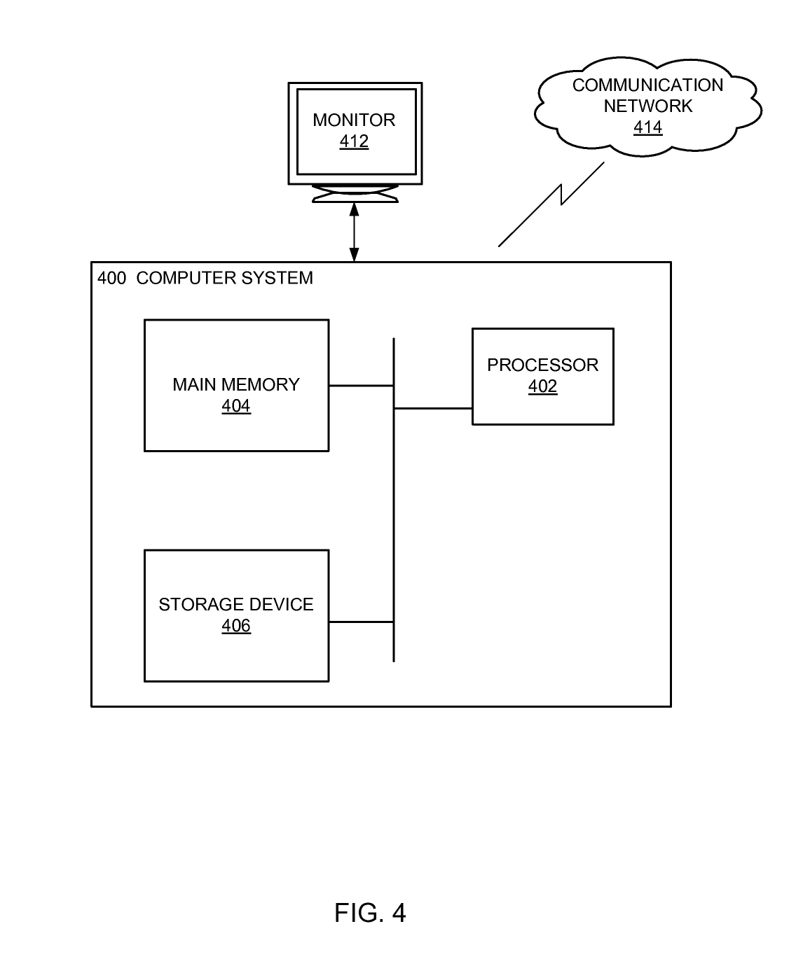

The various inventive concepts described above may be implemented on virtually any type of computer regardless of the platform being used. For example, as shown in FIG. 4, a computer system 400 includes a processor 402, associated memory 404, a storage device 406, and numerous other elements and functionalities typical of today's computers (not shown). The computer 400 may also include input means, such as a keyboard and a mouse and output means, such as a monitor 412. The computer system 400 may be connected to a local area network (LAN) or a Wide area network (e.g., the Internet), such as communication network 414, via a network interface connection (not shown). Those skilled in the art will appreciate that these input and output means may take other forms.

Further, those skilled in the art will appreciate that one or more elements of the computer system 400 may be located at a remote location and connected to the other elements over a network. The invention may be implemented on a distributed system having a plurality of nodes, where each portion of the invention (e.g., the operating system, file system, cache, application(s), etc.) may be located on a different node within the distributed system, and each node may corresponds to a computer system. Alternatively, the node may correspond to a processor with associated physical memory. The node may alternatively correspond to a processor with shared memory and/or resources. Further, software instructions to perform embodiments of the invention may be stored on a tangible computer readable medium such as a compact disc (CD), a diskette, a tape, a digital versatile disk (DVD), or any other suitable tangible computer readable storage device.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for managing a cache comprising:
identifying, using least one processor, a reference to a first empty block of data to be stored in a cache of a file system;
mapping, using the at least on processor, the reference to an existing second empty block of data stored in the cache; and
adding, at the at least one processor, the reference to a cache list maintaining the cache.

2. The method of claim 1, wherein the cache is an adaptive replacement cache implemented in conjunction with dynamic random access memory, wherein the cache list comprises a most recently used (MRU) list and a most frequently used (MFU) list and wherein the existing second empty block of data is permanently stored in the dynamic random access memory.

3. The method of claim 2, wherein mapping the reference to the existing second empty block of data comprises updating a hash entry corresponding to the reference to identify an entry in the MRU or the MFU referring to the existing second empty block of data.

4. The method of claim 1, wherein identifying a reference pointing to the first empty block of data comprises analyzing a checksum value of a block pointer corresponding to the first data block to determine whether the checksum value corresponds to empty data.

5. The method of claim 1, wherein identifying a reference pointing to a first empty block of data comprises checking a flag bit of a block pointer corresponding to the first data block to determine whether the flag indicates empty data.

6. The method of claim 1, wherein the file system is a ZFS file system and wherein the existing second empty block of data is a size equivalent to a maximum block size for the file system.

7. A system for managing a cache comprising:
a memory;
at least one processor in operable communication with the memory, the processor to:
identify a reference to a first empty block of data to be stored in a cache of a file system;
map the reference to an existing second empty block of data stored in the cache; and
add the reference to a cache list maintaining the cache.

8. The system of claim 7, wherein the cache is an adaptive replacement cache implemented in conjunction with dynamic random access memory, wherein the cache list comprises a most recently used (MRU) list and a most frequently used (MFU) list and wherein the existing second empty block of data is permanently stored in the dynamic random access memory.

9. The system of claim 8, wherein to map the reference to the existing second empty block of data comprises updating a hash entry corresponding to the reference to identify an entry in the MRU or the MFU referring to the existing second empty block of data.

10. The system of claim 7, wherein to identify a reference pointing to the first empty block of data comprises analyzing a checksum value of a block pointer corresponding to the first data block to determine whether the checksum value corresponds to empty data.

11. The system of claim 7, wherein to identify a reference pointing to a first empty block of data comprises checking a flag bit of a block pointer corresponding to the first data block to determine whether the flag indicates empty data.

12. The system of claim 7, wherein the file system is a ZFS file system and wherein the existing second empty block of data is a size equivalent to a maximum block size for the file system.

13. A non-transitory computer readable medium encoded with instructions for managing a cache executable by a processor, the instructions comprising:
identify a reference to a first empty block of data to be stored in a cache of a file system;
map the reference to an existing second empty block of data stored in the cache; and
add the reference to a cache list maintaining the cache.

14. The non-transitory computer readable medium claim 13, wherein the cache is an adaptive replacement cache implemented in conjunction with dynamic random access memory, wherein the cache list comprises a most recently used (MRU) list and a most frequently used (MFU) list and wherein the second empty block of data is permanently stored in the dynamic random access memory.

15. The non-transitory computer readable medium claim 14, wherein to map the reference to the existing second empty block of data comprises updating a hash entry corresponding to the reference to identify an entry in the MRU or the MFU referring to the existing second empty block of data.

16. The non-transitory computer readable medium claim 13, wherein to identify a reference pointing to the first empty block of data comprises analyzing a checksum value of a block pointer corresponding to the first data block to determine whether the checksum value corresponds to empty data.

17. The non-transitory computer readable medium claim 13, wherein to identify a reference pointing to a first empty block of data comprises checking a flag bit of a block pointer corresponding to the first data block to determine whether the flag indicates empty data.

18. The non-transitory computer readable medium claim 13, wherein the file system is a ZFS file system and wherein the existing second empty block of data is a size equivalent to a maximum block size for the file system.
